(19) United States
(12) Patent Application Publication
(10) Pub. No.: US 2026/0237404 A1
(43) Pub. Date: Aug. 13, 2026

(54) ACOUSTIC DEVICE

(71) Applicant: AlphaTheta Corporation, Yokohama-shi, Kanagawa (JP)

(72) Inventor: Katsuhiro SHIBA, Yokohama-shi, Kanagawa (JP)

(21) Appl. No.: 19/147,019

(22) PCT Filed: Jan. 13, 2023
(86) PCT No.: PCT/JP2023/000735

§ 371 Date: Jul. 10, 2025

(51) Int. Cl. G11B 19/20

(52) U.S. Cl. CPC G11B 19/2027

(57) ABSTRACT

An acoustic device includes: a base; a shaft member penetrating through the base; a turntable provided on the base, the turntable being rotatable around the shaft member; a movable member movable along the shaft member; and a load adjuster attached to the shaft member, the load adjuster configured to approach the turntable along the shaft member and press an intervening member interposed between the load adjuster and the movable member toward the turntable to adjust a rotation load of the intervening member against the turntable, in which the load adjuster is configured to attract the movable member by magnetic force to hold the intervening member together with the movable member.

### TECHNICAL FIELD

The present invention relates to an acoustic device.

### BACKGROUND ART

Control turntables, which are usable for a music playing process using DVS (Digital Vinyl System) or the like and are operable in the same manner as analog turntables, have been typically known (see, for instance, Non-Patent Literatures 1 and 2).

According to the control turntables disclosed in Non-Patent Literatures 1 and 2, a record disc, through which a spindle penetrates, is held between a platter and a lock adapter. In the turntable disclosed in Non-Patent Literature 1, a user uses a hexagonal wrench to tighten a screw provided to the lock adapter in order to control slippage of the record disc relative to the platter. In the turntable disclosed in Non-Patent Literature 2, the number of spacer provided between the spindle and a slip mat is adjusted to control slippage of the record disc relative to the platter.

### CITATION LIST

### Non-Patent Literature(s)

Non-Patent Literature 1: Rane Corporation, “TWELVE user guide v1.1” on the Internet [Searched Date: Oct. 19, 2022], URL:http://rane-dj.jp/products/twelve

Non-Patent Literature 2: Rane Corporation, “TWELVE MKII user guide” on the Internet [Searched Date: Oct. 19, 2022], URL:http://rane-dj.jp/products/8-products/34-twelve-mkii

### SUMMARY OF THE INVENTION

### Problem(s) to be Solved by the Invention

However, the control turntable disclosed in Non-Patent Literature 1, which requires the annexed hexagonal wrench in order to control slippage of a record disc, necessitates complicated adjustment operation. In addition, it is difficult to control slippage of a record disc while a music piece is being played.

Meanwhile, the control turntable disclosed in Non-Patent Literature 2 requires that spacer(s) of a thickness or the number corresponding to slippage desired by a DJ should be prepared.

In view of the above, an acoustic device capable of easily adjusting a rotation load applied on a rotary body has been desired.

### Means for Solving the Problem(s)

An acoustic device according to a first aspect of the invention includes: base; a shaft member penetrating through the base; a turntable provided on the base, the turntable being rotatable around the shaft member; a movable member provided in a manner movable along the shaft member; and a load adjuster attached to the shaft member, the load adjuster being configured to approach the turntable along the shaft member and press an intervening member interposed between the load adjuster and the movable member toward the turntable to adjust a rotation load of the intervening member on the turntable, in which the load adjuster is configured to attract the movable member by a magnetic force to hold the intervening member together with the movable member.

An acoustic device according to a second aspect of the invention includes: a turntable having a placement surface on which a disc is placeable, the turntable being rotatable together with the disc; a shaft member penetrating through the turntable; a movable member having a contact surface capable of contacting with the disc, the movable member being provided in a manner movable along the shaft member; and a load adjuster attached to the shaft member, the load adjuster being configured to approach the turntable along the shaft member and press the disc interposed between the load adjuster and the movable member toward the turntable to adjust a rotation load of the disc on the turntable, in which the turntable is rotatable around the shaft member, the load adjuster is configured to attract the movable member by a magnetic force to hold the disc together with the movable member, and the movable member is movable between a first position, at which the contact surface is located opposite the load adjuster with respect to the placement surface, and a second position, at which the contact surface is located near the load adjuster with respect to the placement surface.

### BRIEF DESCRIPTION OF DRAWING(S)

FIG. 1 is a perspective view illustrating an acoustic device according to an exemplary embodiment.

FIG. 2 is a plan view illustrating the acoustic device according to the exemplary embodiment.

FIG. 3 is a perspective view illustrating a slip sheet, a slip mat, and an operation disc placed on a turntable of the acoustic device according to the exemplary embodiment.

FIG. 4 illustrates the acoustic device according to the exemplary embodiment, from which a second casing is removed.

FIG. 5 illustrates a cross section of the acoustic device taken along a V-V line in FIG. 2.

FIG. 6 is a perspective view illustrating a rotary shaft portion and a load adjuster according to the exemplary embodiment.

FIG. 7 is a cross-sectional view illustrating the rotary shaft portion and the load adjuster according to the exemplary embodiment.

FIG. 8 is a perspective view illustrating a shaft member and a table according to the exemplary embodiment.

FIG. 9 is an exploded perspective view illustrating the load adjuster according to the exemplary embodiment.

FIG. 10 is another exploded perspective view illustrating the load adjuster according to the exemplary embodiment.

FIG. 11 is an exploded perspective view illustrating an adjusting member according to the exemplary embodiment.

FIG. 12 is an exploded perspective view illustrating an intermediate member according to the exemplary embodiment.

FIG. 13 is a cross-sectional view illustrating the intermediate member and a magnet according to the exemplary embodiment.

FIG. 14 is a side elevational view illustrating the rotary shaft portion and an intervening member according to the exemplary embodiment.

FIG. 15 is a side elevational view illustrating the rotary shaft portion, the load adjuster, and the intervening member according to the exemplary embodiment.

FIG. 16 is another side elevational view illustrating the rotary shaft portion, the load adjuster, and the intervening member according to the exemplary embodiment.

### DESCRIPTION OF EXEMPLARY EMBODIMENT(S)

Description will be made below on an exemplary embodiment of the invention with reference to attached drawings.

### Schematic Configuration of Acoustic Device

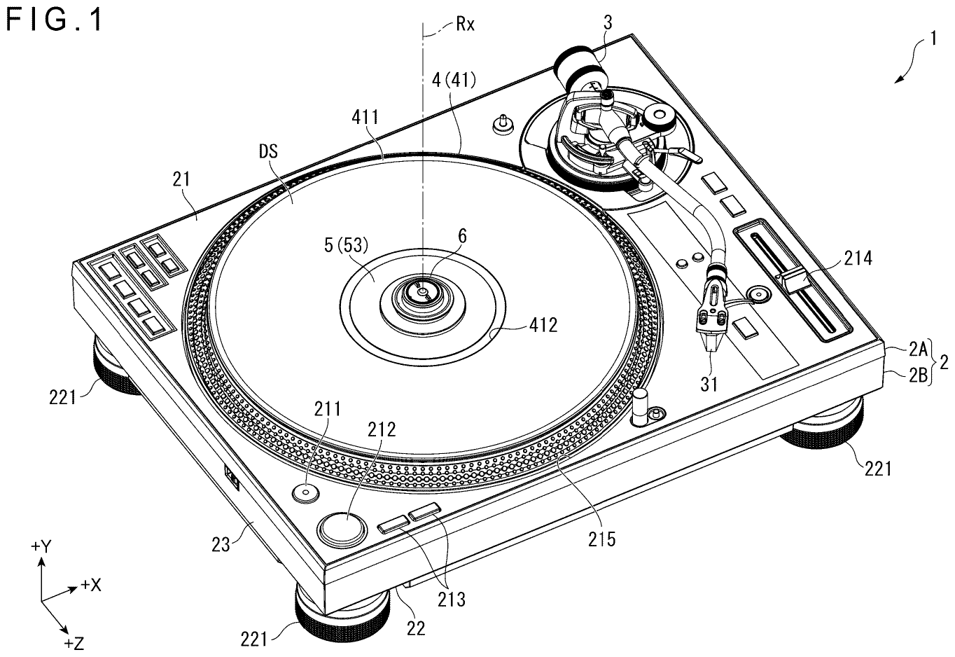

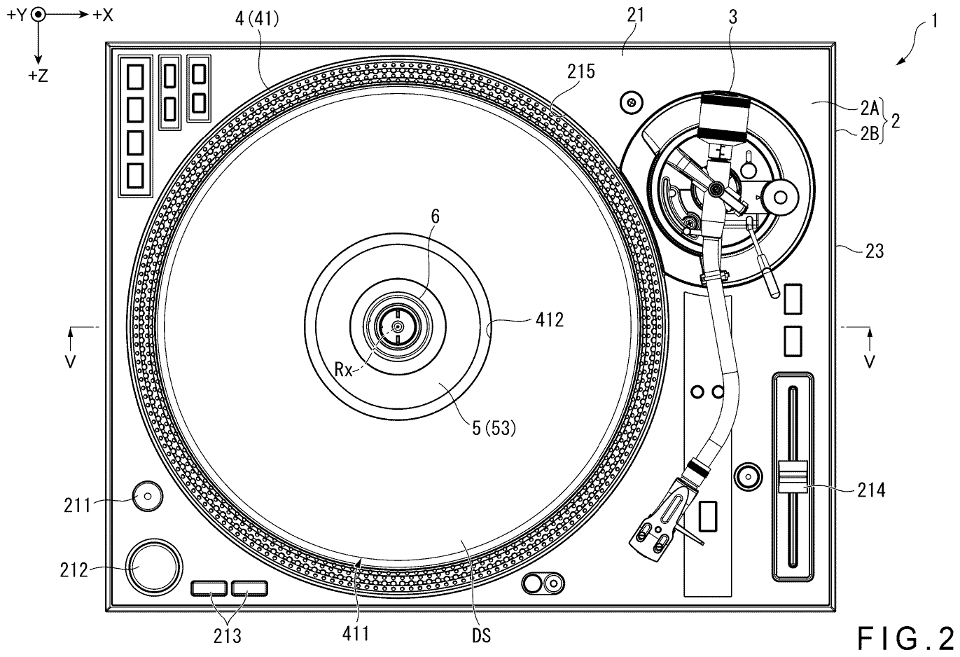

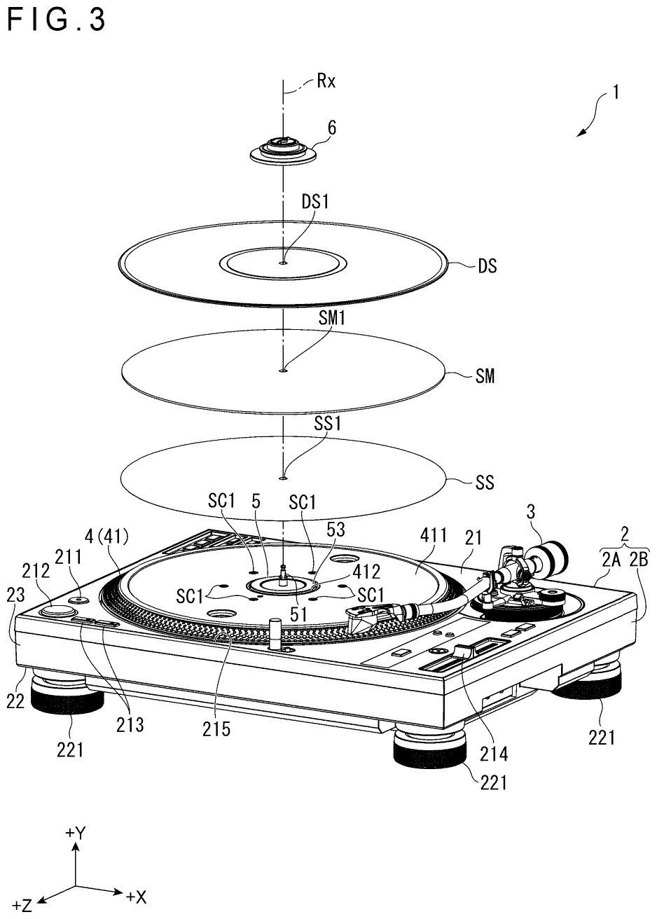

FIG. 1 is a perspective view illustrating an acoustic device 1 according to the exemplary embodiment. FIG. 2 is a plan view illustrating the acoustic device 1. FIG. 3 is a perspective view illustrating a slip sheet SS, a slip mat SM, and an operation disc DS that are placed on a turntable 41 of the acoustic device 1.

The acoustic device 1 according to the exemplary embodiment includes a casing 2, a tone arm 3, a rotary body 4, a rotary shaft portion 5, and a load adjuster 6 as shown in FIGS. 1 to 3, and outputs signals corresponding to a user's operation on the operation disc DS. Specifically, the acoustic device 1 transmits operation information including rotation information indicating a rotation state of the operation disc DS. The rotation information includes a rotary angle, rotation direction, rotation speed and the like of the operation disc DS. The acoustic device 1 also transmits information acquired from the operation disc DS through the tone arm 3.

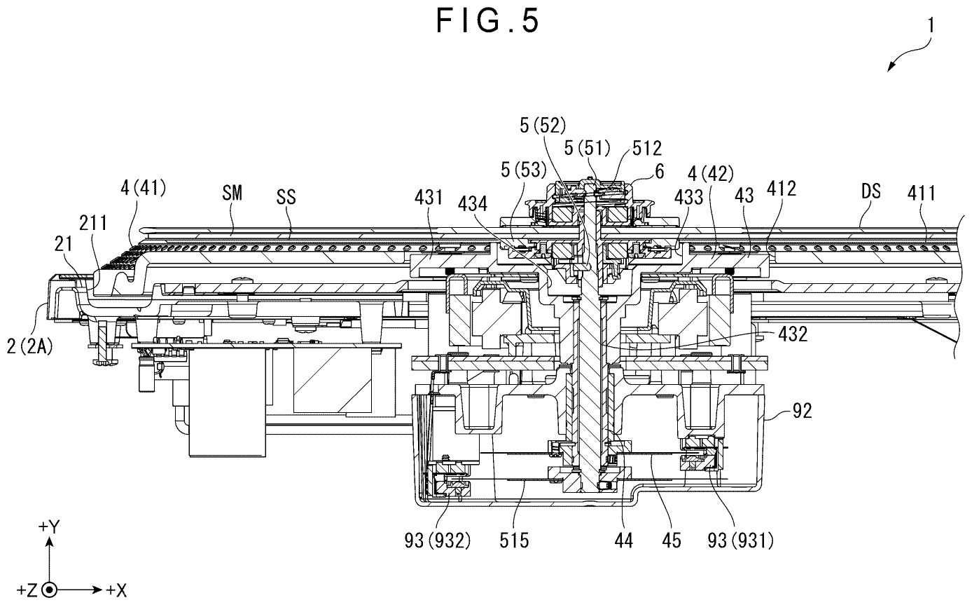

As described in detail later, the turntable 41 of the rotary body 4, which supports an intervening member MT including the slip sheet SS, the slip mat SM, and the operation disc DS as shown in FIG. 3, rotates around a rotation axis Rx. The intervening member MT is an object to be held by a later-described table 53 (see FIG. 5) and the load adjuster 6.

The operation disc DS is an analog record disc recorded thereon with audio information, a time code record disc recorded thereon with a time code, or a disc imitating an analog record disc.

The operation disc DS is placed on a placement surface 411 of the turntable 41 via the slip sheet SS and the slip mat SM. The operation disc DS is held by the table 53 of the rotary shaft portion 5 and the load adjuster 6. The operation disc DS is rotated together and coaxially with the turntable 41. The operation disc DS, which is rotatable in the rotation direction of the turntable 41 relative to the turntable 41, is also relatively rotatable in a direction opposite the rotation direction of the turntable 41. A user thus can perform a rotation operation (e.g., scratching) on the operation disc DS.

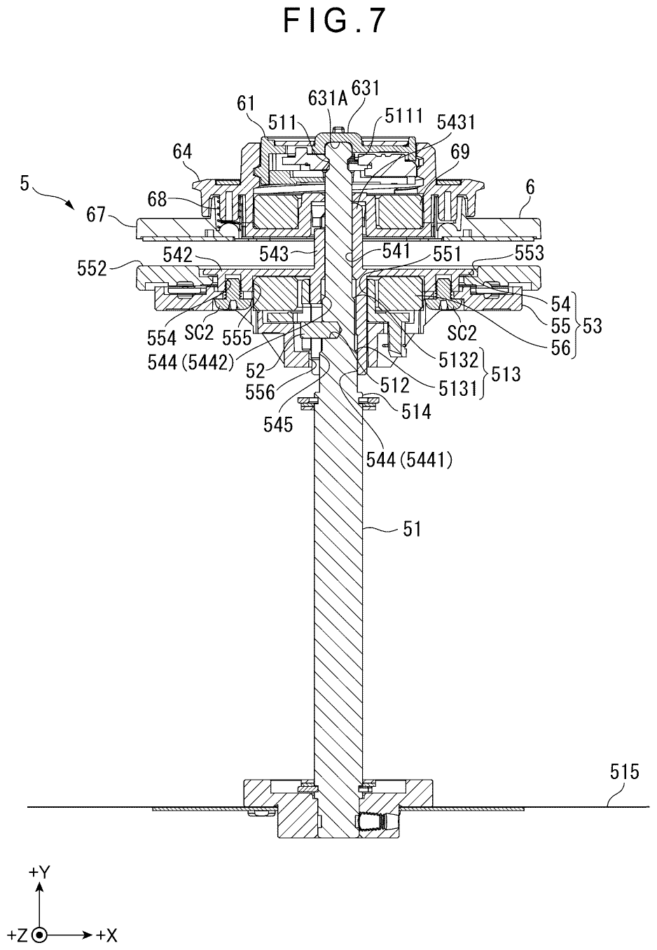

The operation disc DS has a substantially circular hole DS1 penetrating through the operation disc DS at the center of the operation disc DS. The hole DS1 is a hole for a meshing portion 543 (see FIG. 7) provided outside of the shaft member 51 of the rotary shaft portion 5 to be inserted.

The slip sheet SS and the slip mat SM are each a friction reducing member. Each of the slip sheet SS and the slip mat SM is a disc of substantially the same size as that of the operation disc DS. The material of each of the slip sheet SS and the slip mat SM can be optionally changed depending on user's taste or the like. Commercially available slip sheet and slip mat may be directly used without change.

The slip sheet SS has, at the center thereof, a circular hole SS1 through which the meshing portion 543 of the rotary shaft portion 5 penetrates. The slip mat SM has, at the center thereof, a circular hole SM1 through which the meshing portion 543 penetrates.

The slip sheet SS and the slip mat SM reduce a friction force generated between the operation disc DS and the placement surface 411, thereby reducing a friction force caused when the operation disc DS is rotated relative to the placement surface 411. In other words, the slip sheet SS rotated integrally with the turntable 41 and the slip mat SM rotated integrally with the operation disc DS are provided in order to smoothen the rotation of the operation disc DS relative to the placement surface 411.

It should be noted that the slip sheet SS and the slip mat SM are optionally omitted when the operation disc DS slips well on the placement surface 411 (e.g. when the surface roughness of the placement surface 411 is small). In this case, the intervening member MT is provided by the operation disc DS.

As detailed later, the intervening member MT is pushed upward from below by the table 53 to be spaced from the placement surface 411 and, in addition, pressed by the load adjuster 6 toward the turntable 41. The rotation load of the operation disc DS is thus adjusted.

In the following description, three directions orthogonal to each other are defined as a +X direction, +Y direction, and +Z direction. The +Y direction is a direction away from a base 21 (a top surface of the casing 2) along a normal line of the base 21. In other words, the +Y direction is a direction opposite a vertical direction in which the acoustic device 1 is installed on an installation surface. When the acoustic device 1 is seen in the +Y direction, the +X direction is a right direction and the +Z direction is a downward direction. Though not illustrated, a direction opposite the +X, +Y, and +Z directions will be respectively referred to as −X, −Y, and −Z directions hereinafter. Further, axes along the +X direction, +Y direction, and +Z direction will be respectively referred to as an X axis, Y axis, and Z axis hereinafter.

### Configuration of Casing

As illustrated in FIGS. 1 to 3, the casing 2 is a substantially rectangular parallelepiped component. The casing 2, which includes a first casing 2A and a second casing 2B located in the −Y direction with respect to the first casing 2A, is provided in a form of a combination of the first casing 2A and the second casing 2B. The casing 2 includes the base 21, a bottom surface 22, and side surfaces 23.

Among the above, the bottom surface 22 is a surface of the casing 2 facing in the −Y direction, which is a surface facing the installation surface on which the acoustic device 1 is installed. The bottom surface 22 includes a plurality of legs 221 that are in contact with the installation surface.

The side surfaces 23 are lateral surfaces of the casing 2 in the ±X directions and side surfaces in the ±Z directions.

The base 21, which is a surface of the first casing 2A facing in the +Y direction, defines the top surface of the casing 2. Various buttons and the tone arm 3 are provided on the base 21. In addition, the turntable 41 of the rotary body 4 is exposed on the base 21. Specifically, the various buttons provided on the base 21 include a power switch 211, a start/stop button 212, a speed change button 213, and a tempo slider 214.

The power switch 211, the start/stop button 212, and the speed change button 213 are provided adjacent to the turntable 41. A user can rotate and stop the turntable 41 by operating the power switch 211 and the start/stop button 212. The speed change button 213, when being operated by a user, sets the rotation speed of the turntable 41 to one of 33 RPM (suitable speed for playing LP disc) and 45 RPM (suitable speed for playing EP disc).

The tempo slider 214 is provided at a side of the base 21 in the +X direction in a manner slidable along the Z axis. A user can adjust the rotation speed of the rotary body 4 by operating the tempo slider 214 to adjust the rotation speed of the operation disc DS.

A circular recess 215 opened in the +Y direction is provided to the base 21. The turntable 41 of the rotary body 4 is located in the recess 215.

### Configuration of Tone Arm

The tone arm 3 is configured to apply an appropriate needle pressure to acquire audio information from an analog record disc or acquire a time code from a time code record disc. The tone arm 3, which is provided at a corner of the base 21 in the +X and −Z directions, is rotatable around a rotation axis extending along the Y axis.

The tone arm 3 includes a head shell 31 to which a cartridge provided with a phonograph needle for playing a record disc is attached.

### Upper Configuration of Rotary Body

The rotary body 4 is rotated by a later-described drive unit 91 around the rotation axis Rx extending along the Y axis. The rotary body 4 is provided with the turntable 41 that defines a part of the rotary body 4 in the +Y direction, and a later-described support member 42 (see FIG. 5). The support member 42 will be detailed later.

The turntable 41 is provided on the base 21. The turntable 41 is a substantially truncated cone component whose outer diameter lessens toward the +Y direction. The turntable 41 is provided with a placement surface 411 on which the slip sheet SS, the slip mat SM, and the operation disc DS are placeable. The placement surface 411 is the top surface of the turntable 41 facing in the +Y direction and orthogonal to the rotation axis Rx.

The turntable 41 includes a substantially circular opening 412 at the center as viewed in the +Y direction. The rotary shaft portion 5 is provided within the opening 412. A shaft member 51, which is a part of the rotary shaft portion 5, penetrates through the opening 412 along the Y axis. In other words, the shaft member 51 penetrates through the turntable 41 along the Y axis. The table 53 of the rotary shaft portion 5 is movable through the opening 412 in the ±Y directions with respect to the turntable 41.

The turntable 41 is rotatable around the shaft member 51.

### Configuration of Interior of Casing

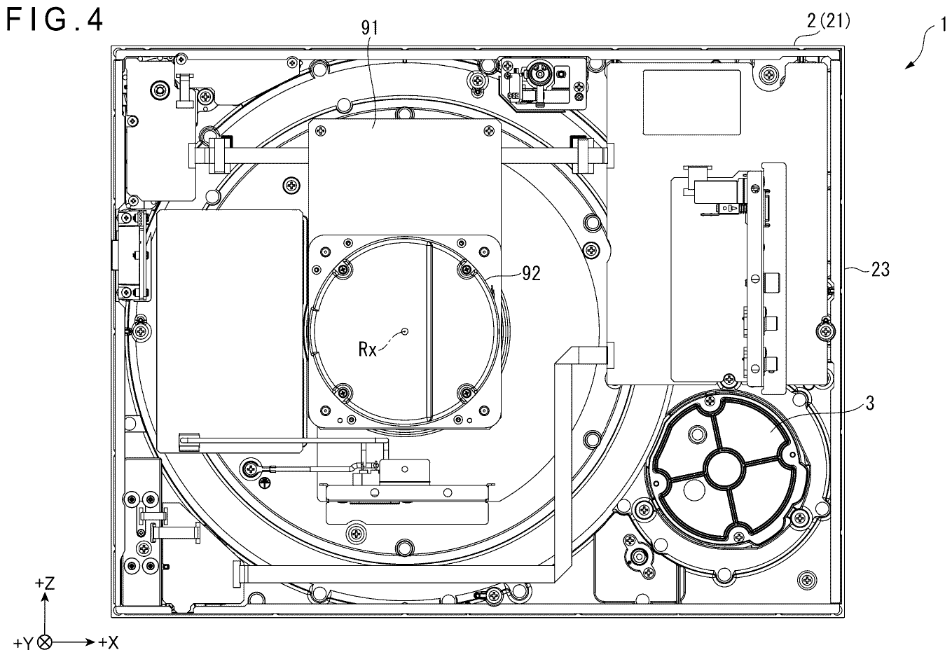

FIG. 4 illustrates the acoustic device 1 with the second casing 2B being removed, viewed in the −Y direction. FIG. 5 illustrates a cross section of the acoustic device 1 taken along a V-V line in FIG. 2. It should be noted that the second casing 2B and a part of components inside the casing 2 are not illustrated in FIG. 5.

The acoustic device 1 includes the drive unit 91, a rotation support portion 92 (see FIG. 4), and a rotation detector 93 (see FIG. 5) inside the casing 2.

The drive unit 91 as illustrated in FIG. 4 is configured to rotate the rotary body 4 at the rotation speed set by the speed change button 213 or the tempo slider 214. The rotation support portion 92, which is a bottomed hollow cylindrical component fixed inside the casing 2, supports the support member 42 of the rotary body 4 and the shaft member 51 of the rotary shaft portion 5 so that the support member 42 and the shaft member 51 are rotatable within the rotation support portion 92. The rotation detector 93 is provided inside the rotation support portion 92.

As illustrated in FIG. 5, the rotation detector 93 includes a first detector 931 for detecting the rotation state of the turntable 41 and a second detector 932 for detecting the rotation state of the rotary shaft portion 5 and, consequently, of the operation disc DS. The rotation state of the turntable 41 detected by the first detector 931 is used in order to control the rotation of the turntable 41. The rotation state of the rotary shaft portion 5 detected by the second detector 932 is optionally transmitted to an outside as the rotation state of the operation disc DS.

### Lower Configuration of Rotary Body

As described above, the rotary body 4 includes the support member 42 illustrated in FIG. 5 in addition to the turntable 41.

While supporting the turntable 41, the support member 42 is supported by the rotation support portion 92 in a manner rotatable around the rotation axis Rx. The support member 42 includes a first cylindrical portion 43, a second cylindrical portion 44, and an enlarged portion 45.

The first cylindrical portion 43 is substantially Y-shaped as viewed in the +Z direction. The first cylindrical portion 43 includes a connecting portion 431, a through portion 432, a first recess 433, and a second recess 434.

The connecting portion 431 is a component defining an end of the first cylindrical portion 43 in the +Y direction. The connecting portion 431, which is an outer peripheral portion of the first cylindrical portion 43, is annular as viewed in the +Y direction. The connecting portion 431 is connected to a surface of the turntable 41 opposite the placement surface 411 using screws SC1 (see FIG. 3).

The through portion 432 penetrates through the first cylindrical portion 43 along the Y axis. The shaft member 51 penetrates through the inside of the through portion 432 along the Y axis.

The first recess 433 is provided at the center of the first cylindrical portion 43 and inside the connecting portion 431 as viewed in the +Y direction. The first recess 433 is opened in the +Y direction. A part of the table 53 of the rotary shaft portion 5 in the +Y direction is located within the first recess 433.

The second recess 434 is a part continuous with a bottom part of the first recess 433 in the −Y direction with respect to the first recess 433. A part of the table 53 in the −Y direction is located within the second recess 434.

### Configuration of Rotary Shaft Portion

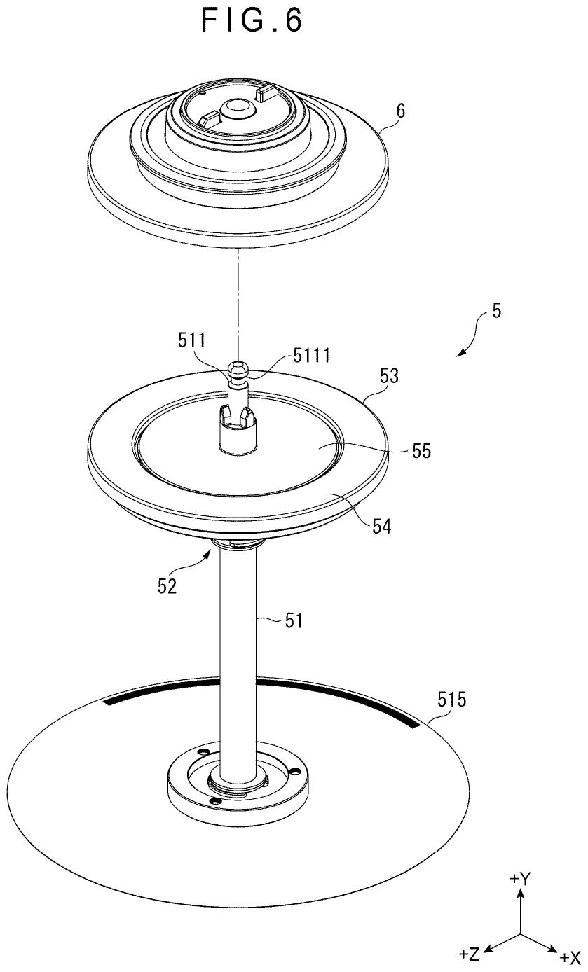

FIG. 6 is a perspective view illustrating the rotary shaft portion 5 and the load adjuster 6 viewed in the +Y direction. FIG. 7 illustrates a cross section of the rotary shaft portion 5 and the load adjuster 6 along an XY plane.

The rotary shaft portion 5 rotates around the rotation axis Rx integrally with the support member 42 and, consequently, with the rotary body 4. The rotary shaft portion 5 can also rotate around the rotation axis Rx integrally with the operation disc DS held together with the load adjuster 6. As illustrated in FIGS. 5 to 7, the rotary shaft portion 5 includes the shaft member 51, a connector 52, and the table 53.

### Configuration of Shaft Member

The shaft member 51 penetrates through the base 21 and the rotary body 4 along the Y axis. In other words, the shaft member 51 penetrates through the turntable 41 along the Y axis. The center axis of the shaft member 51 along the Y axis is coaxial with the rotation axis Rx.

The shaft member 51 includes a recess 511, a fixation hole 512, a step portion 513, a movement restrictor 514, and an enlarged portion 515.

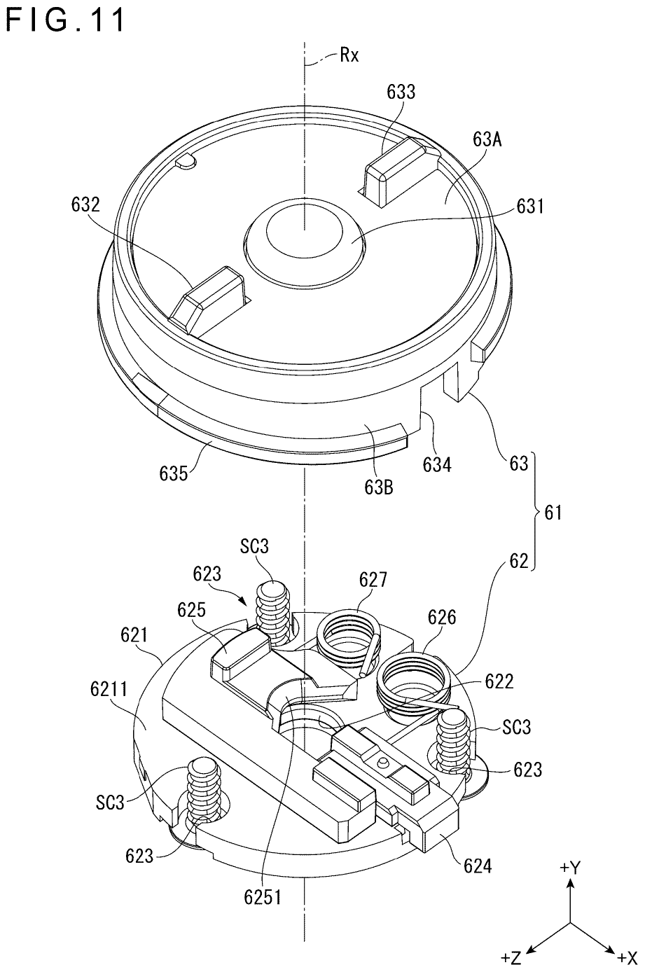

The recess 511 is a part dented along a circumferential direction of the shaft member 51 around the rotation axis Rx and provided at an end of the shaft member 51 in the +Y direction. A claw 625 of the load adjuster 6 is received in the recess 511 in a manner slidable along the XZ plane (see FIG. 11). It should be noted that a surface 5111 of the recess 511 facing in the −Y direction is slanted so that its diameter is enlarged toward the +Y direction. Accordingly, when a user moves the load adjuster 6 along the shaft member 51 in the +Y direction, the claw 625 comes off from the recess 511, so that the load adjuster 6 can be detached from the shaft member 51.

As illustrated in FIG. 7, the fixation hole 512 is a hole for the connector 52 connecting the shaft member 51 and the table 53 to be received and fixed. The connector 52 connects the shaft member 51 and the table 53.

The step portion 513 is provided on the outer circumferential surface of the shaft member 51 around the rotation axis Rx. The step portion 513 includes a first step 5131 and a second step 5132.

The first step 5131 is a diameter-reduced portion extending along the circumferential direction around the rotation axis Rx.

The second step 5132 is provided at a part in the +Y direction with respect to the first step 5131. The second step 5132 is a portion extending along the circumferential direction around the rotation axis Rx, the diameter of the second step 5132 being smaller than that of the first step 5131.

The movement restrictor 514 is provided at a position in the −Y direction with respect to the step portion 513. The movement restrictor 514 is in contact with a part of the table 53 to restrict further movement of the table 53 in the −Y direction, when the table 53 is moved in the −Y direction.

The enlarged portion 515, which is provided at an end of the shaft member 51 in the −Y direction, is a circular portion whose diameter is enlarged as viewed in the +Y direction. An end of the enlarged portion 515 is inserted into the second detector 932, so that the rotation state of the rotary shaft portion 5 and the load adjuster 6 and, consequently, the rotation state of the operation disc DS are detected by the second detector 932.

### Configuration of Table

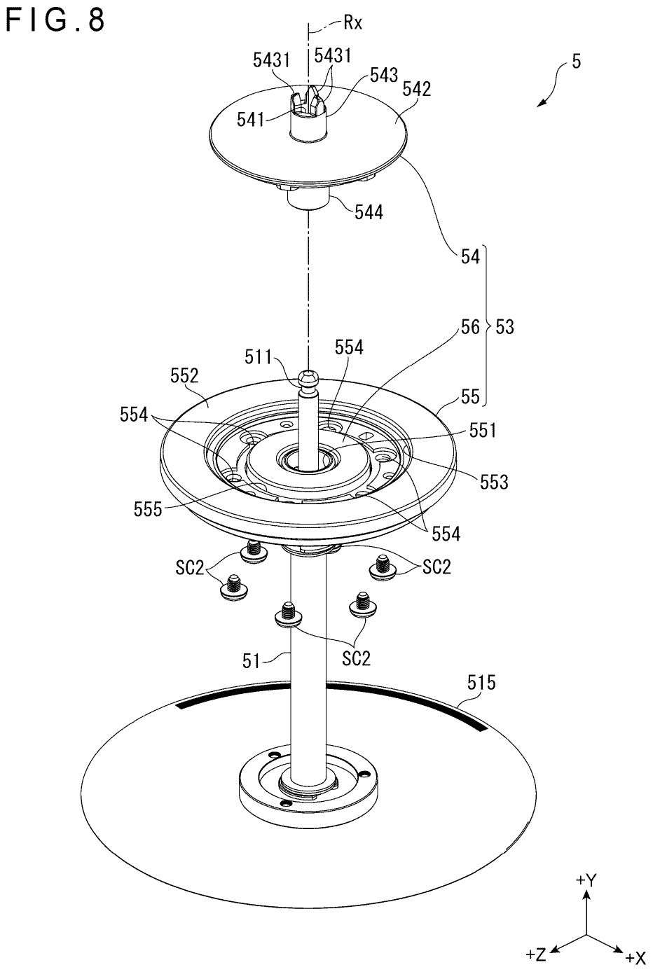

FIG. 8 is a perspective view illustrating the shaft member 51 and the table 53. More specifically, FIG. 8 is a perspective view illustrating the table 53 whose meshing member 54 is separated from a holding member 55.

The table 53 is a movable member that is provided to the shaft member 51 in a manner movable along the shaft member 51 in the ±Y directions. When the load adjuster 6 is attached to the shaft member 51, an intervening member MT is interposed and held between the table 53 and the load adjuster 6.

As illustrated in FIGS. 7 and 8, the table 53 includes the meshing member 54, the holding member 55, and a magnet 56.

### Configuration of Meshing Member

The meshing member 54 is attached to a circumference of the shaft member 51 to be meshed with the load adjuster 6 attached to the shaft member 51. The meshing member 54 includes a through portion 541, a cover portion 542, a meshing portion 543, a cylindrical portion 544, and a guide hole 545.

The through portion 541 penetrates through the meshing member 54 along the Y axis. The shaft member 51 is inserted into the through portion 541. The through portion 541 is provided at the center of the cover portion 542 as viewed in the +Y direction.

The cover portion 542, which is circular as viewed in the +Y direction, covers a side of the receiver portion 553 of the holding member 55 in the +Y direction.

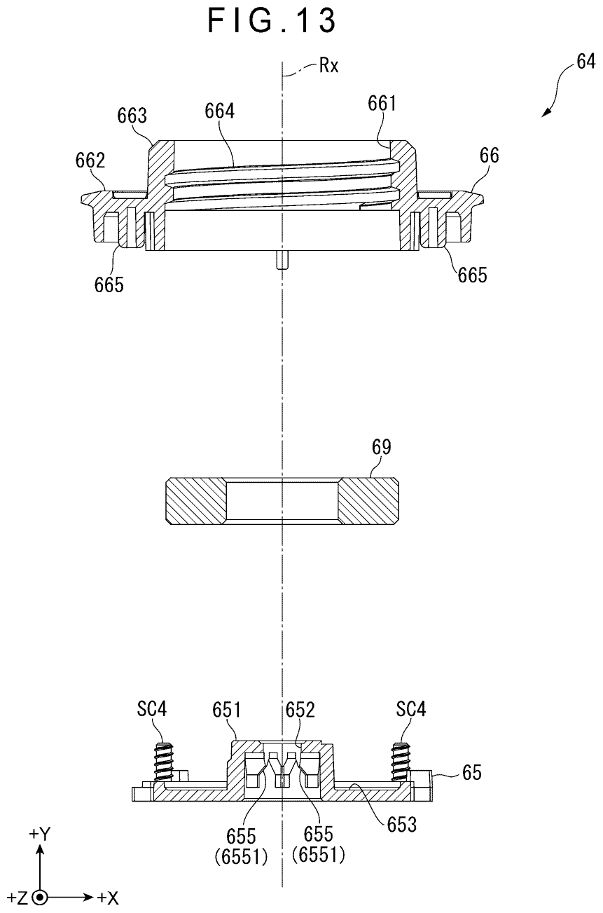

The meshing portion 543 is a hollow cylinder protruding in the +Y direction from the center of the cover portion 542. In other words, the meshing portion 543 is a hollow cylinder protruding in the +Y direction from the periphery of the through portion 541. The meshing portion 543 includes a plurality of convex portions 5431 protruding in the +Y direction from an end of the meshing portion 543 in the +Y direction and provided at equal intervals along the circumferential direction of the meshing portion 543. The plurality of convex portions 5431 mesh with later-described meshing portion 655 (see FIG. 13) of the load adjuster 6, so that the table 53 and, consequently, the rotary shaft portion 5 are capable of being rotated integrally with the load adjuster 6 around the rotation axis Rx.

The cylindrical portion 544 is a hollow cylinder protruding in the −Y direction from the center of the cover portion 542 as viewed in the −Y direction. The through portion 541 penetrates through the cylindrical portion 544 along the Y axis. When the table 53 is attached to the shaft member 51, the cylindrical portion 544 surrounds the shaft member 51. As illustrated in FIG. 7, the cylindrical portion 544 includes a first cylindrical portion 5441 and a second cylindrical portion 5442 corresponding to the first step 5131 and the second step 5132, respectively, on an inner circumference thereof.

The guide hole 545 is an elongated hole whose long diameter extends along the Y axis. The connector 52 inserted into the fixation hole 512 penetrates through the guide hole 545.

### Configuration of Holding Member

As illustrated in FIG. 8, the holding member 55 is a circular component as viewed in the +Y direction. An outer diameter dimension of the holding member 55 as viewed in the +Y direction is larger than the outer diameter dimension of the meshing member 54 as viewed in the +Y direction. The holding member 55 is connected to the meshing member 54 using screws SC2 inserted in the −Y direction. The holding member 55 is exposed in the +Y direction through the opening 412 of the turntable 41 to hold the intervening member MT along the Y axis together with the load adjuster 6. The holding member 55 also holds the magnet 56 that interacts with the load adjuster 6.

The holding member 55 includes an insertion hole 551, a contact surface 552, the receiver portion 553, and a guide hole 556.

The insertion hole 551 penetrates through the holding member 55 along the Y axis. The cylindrical portion 544 of the meshing member 54 is inserted into the insertion hole 551.

The contact surface 552 is a surface of the holding member 55 facing in the +Y direction. The contact surface 552 is in contact with the intervening member MT to hold the intervening member MT together with the load adjuster 6 along the Y axis.

The receiver portion 553, which is a recess provided around the insertion hole 551, is ring-shaped as viewed in the +Y direction. A plurality of holes 554 for the screws SC2 to be inserted in the −Y direction and, in addition, a ring-shaped recess 555 are provided at the bottom of the receiver portion 553. The ring-shaped magnet 56 is placed in the recess 555 in the +Y direction. It should be noted that, when the meshing member 54 and the holding member 55 are connected by the screws SC2, the receiver portion 553 is covered with the cover portion 542. In other words, the magnet 56 is not exposed to an outside of the table 53.

As illustrated in FIG. 7, the guide hole 556 is an elongated hole whose long diameter extends along the Y axis. The connector 52, which is a pin inserted into the fixation hole 512 through the guide hole 545, is inserted into the guide hole 556. Though not illustrated in detail, the guide hole 556 overlaps the guide hole 545 as viewed in a direction in which the connector 52 is inserted into the fixation hole 512. Accordingly, the table 53 provided with the holding member 55, which is rotatable together with the shaft member 51 around the rotation axis Rx extending along the Y axis, is also movable in the ±Y directions along and relative to the shaft member 51.

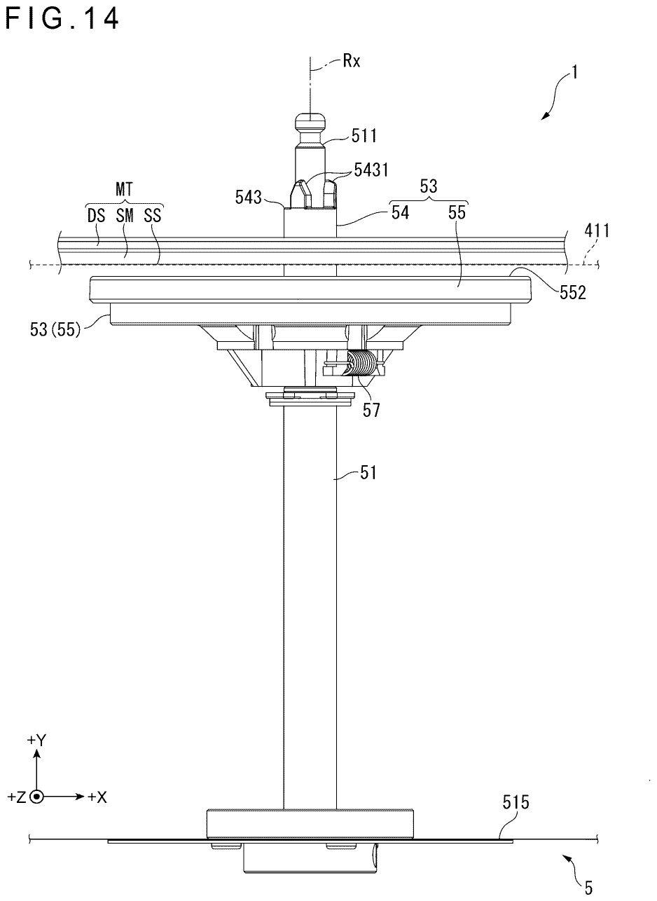

Though not illustrated in FIGS. 7 and 8, the table 53 includes a biasing member 57 (see FIG. 14) for restraining shakiness from being caused between the connector 52 fixed on the shaft member 51 and each of the meshing member 54 and the holding member 55.

It should be noted that the table 53 is located at a position (first position) contacting the movement restrictor 514 when the load adjuster 6 is not attached to the shaft member 51. While the table 53 is located at the first position, the contact surface 552 is located in the −Y direction with respect to the placement surface 411 of the turntable 41.

In contrast, when the load adjuster 6 is attached to the shaft member 51, the contact surface 552 can be located in the +Y direction with respect to the placement surface 411 of the turntable 41, depending on the position of the load adjuster 6.

### Configuration of Load Adjuster

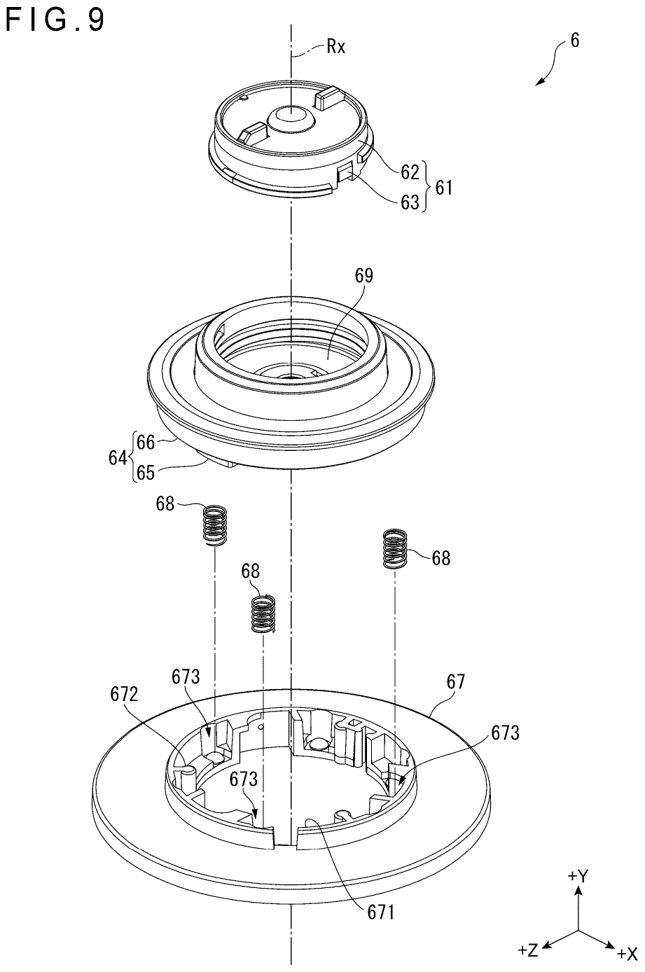

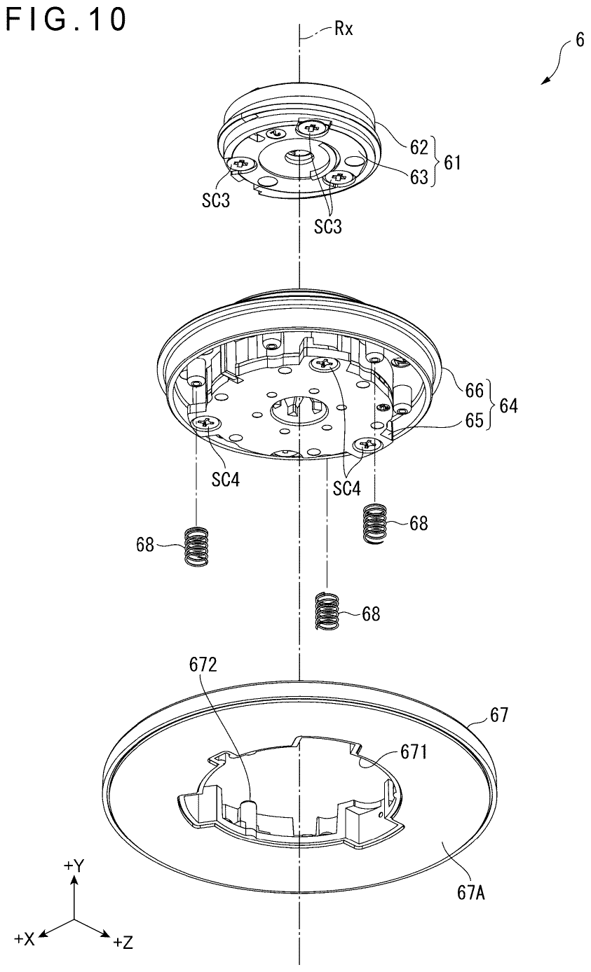

FIGS. 9 and 10 are each an exploded perspective view illustrating the load adjuster 6. More specifically, FIG. 9 is an exploded perspective view illustrating the load adjuster 6 as viewed in the +Y direction, whereas FIG. 10 is an exploded perspective view illustrating the load adjuster 6 as viewed in the −Y direction.

As described above, the load adjuster 6 is attached to the shaft member 51 to attract the table 53 and hold the intervening member MT along the Y axis together with the table 53. Then, a part of the load adjuster 6 approaches the turntable 41 and presses the intervening member MT interposed between the load adjuster 6 and the table 53 toward the turntable 41, thereby adjusting a rotation load of the intervening member MT applied on the turntable 41.

The load adjuster 6 includes an adjusting member 61, an intermediate member 64, a press member 67, and biasing members 68 as illustrated in FIGS. 6, 7, 9, and 10 and, in addition, a magnet 69 as illustrated in FIGS. 7 and 9.

### Configuration of Adjusting Member

FIG. 11 is an exploded perspective view illustrating the adjusting member 61 as viewed in the +Y direction.

The adjusting member 61 is configured to move the intermediate member 64 along the Y axis to adjust the position of the press member 67 and, consequently, the pressing force applied on the intervening member MT. As illustrated in FIG. 11, the adjusting member 61 includes a locking member 62 and a cover member 63.

### Configuration of Locking Member

The locking member 62 is fixed on the cover member 63 by a plurality of screws SC3. The locking member 62 locks an entirety of the adjusting member 61 on the shaft member 51. The locking member 62 includes a base member 621, a restricting member 624, the claw 625, and biasing members 626, 627.

The base member 621 is a circular plate component as viewed in the +Y direction. The base member 621 includes a through opening 622 and a plurality of holes 623.

The through opening 622, which is provided at the center of the base member 621 as viewed in the +Y direction, penetrates through the base member 621 along the Y axis. The shaft member 51 penetrates through the through opening 622 along the Y axis.

The plurality of holes 623 are provided along an outer periphery of the base member 621 substantially at equal intervals as viewed in the +Y direction. The screws SC3 are each inserted in the −Y direction into the corresponding one of the plurality of holes 623. The screws SC3 inserted through the holes 623 are fixed to the cover member 63 to integrate the locking member 62 and the cover member 63.

The restricting member 624 and the claw 625 are provided on a surface 6211 of the base member 621 in the +Y direction with through opening 622 therebetween.

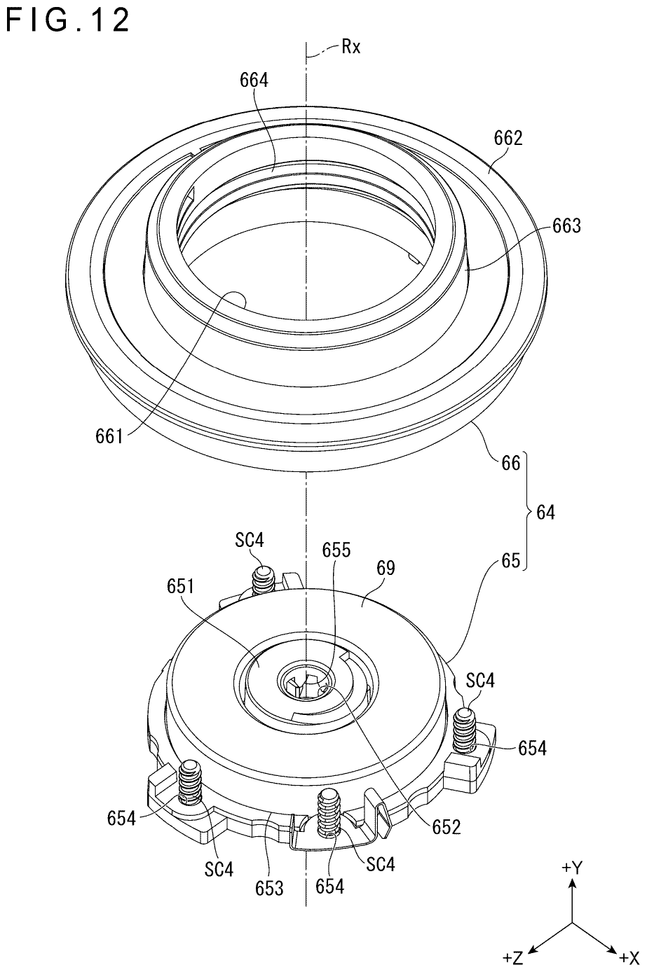

The restricting member 624 is biased by the biasing member 626 in a direction away from the through opening 622. The restricting member 624, which presses the meshing member 66 (see FIG. 12) of the intermediate member 64, serves as a brake for restricting the adjusting member 61 from being easily rotated.

The claw 625 is provided on the base member 621 in a manner movable in a direction toward the through opening 622.

The biasing member 626 is a twisted coil spring whose one end is connected to the restricting member 624 and the other end is fixed to the base member 621. The biasing member 627 is a twisted coil spring whose one end is connected to the claw 625 and the other end is fixed to the base member 621. It should however be noted that the biasing members 626, 627 are each not necessarily in a form of a twisted coil spring.

The claw 625 biased by the biasing member 627 in a direction toward the through opening 622 is inserted into the recess 511 (see FIGS. 6 and 7) of the shaft member 51 inserted through the through opening 622. The adjusting member 61 and the load adjuster 6 are thus attached to the shaft member 51.

The claw 625 as described above includes a slant surface 6251 corresponding to the surface 5111 of the recess 511 at an end inserted into the recess 511. Accordingly, when the adjusting member 61 is moved in the +Y direction away from the shaft member 51, the claw 625 is moved along the surface 5111 in a direction away from the through opening 622 against the biasing force of the biasing member 627. The adjusting member 61 and, consequently, the load adjuster 6 can thus be detached from the shaft member 51.

### Configuration of Cover Member

The cover member 63 is combined with the locking member 62 to cover a side of the locking member 62 in the +Y direction. The cover member 63 is a bottomed cylindrical component with a substantially circular profile as viewed in the +Y direction and opened in the −Y direction. The cover member 63 includes a protrusion 631, grip portions 632, 633, a cut 634, and an outer circumferential protrusion 635.

The protrusion 631, which is provided on a top surface 63A of the cover member 63 facing in the +Y direction, protrudes from the top surface 63A in the +Y direction substantially in a form of a hemisphere. As illustrated in FIG. 7, an inner surface 631A of the protrusion 631 is shaped in a form corresponding to an end of the shaft member 51 in the +Y direction. When the load adjuster 6 is attached to the shaft member 51, the end in the +Y direction of the shaft member 51, which is inserted through the through opening 622 of the locking member 62 in the +Y direction, is in contact with the inner surface 631A.

It should be noted that the above-described claw 625 is located at such a position as being insertable into the recess 511 when the end of the shaft member 51 is in contact with the inner surface 631A.

The grip portions 632, 633 protrude from the top surface 63A at positions across the protrusion 631. The grip portions 632, 633 are held by a user when the adjusting member 61 is rotated relative to the intermediate member 64.

The restricting member 624 is inserted through the cut 634 along the +X direction.

The outer circumferential protrusion 635 protrudes outward from an outer circumferential surface 63B of the cover member 63 around the rotation axis Rx. The outer circumferential protrusion 635 is in a form of a helix ascending in the +Y direction as going clockwise as viewed in the +Y direction.

The outer circumferential protrusion 635 meshes with a helical groove 664 provided on the intermediate member 64 when the adjusting member 61 and the intermediate member 64 are combined, and moves the intermediate member 64 in the ±Y direction as the adjusting member 61 rotates around the rotation axis Rx. In other words, the outer circumferential protrusion 635 and the helical groove 664 define a cam configuration for moving the intermediate member 64 as the adjusting member 61 rotates. Specifically, the adjusting member 61 provided with the outer circumferential protrusion 635 defines a cam and the intermediate member 64 provided with the helical groove 664 defines a follower of the cam.

### Configuration of Intermediate Member

FIG. 12 is an exploded perspective view illustrating the intermediate member 64 as viewed in the +Y direction. FIG. 13 is a cross-sectional view illustrating the intermediate member 64 and the magnet 69 housed in the intermediate member 64. Specifically, FIG. 13 illustrates a cross section of the intermediate member 64 and the magnet 69 along an XY plane.

The intermediate member 64 is movable in the ±Y directions as the adjusting member 61 rotates around the rotation axis Rx to move the press member 67 in the ±Y directions and press the intervening member MT toward the turntable 41. As illustrated in FIGS. 12 and 13, the intermediate member 64 includes a holding member 65 and the meshing member 66 covering a side of the holding member 65 in the +Y direction.

### Configuration of Holding Member

The holding member 65, which has a substantially circular profile as viewed in the +Y direction, is combined with the meshing member 66 with the magnet 69 being held therebetween. The holding member 65 includes a cylindrical portion 651, a through portion 652, a receiver portion 653, and a plurality of insertion holes 654.

The cylindrical portion 651, which is provided at the center of the holding member 65 as viewed in the +Y direction, is a hollow cylindrical portion protruding in the +Y direction from a surface of the holding member 65 facing in the +Y direction.

The through portion 652 penetrating through the holding member 65 along the Y axis is provided in the cylindrical portion 651. The shaft member 51 is inserted into the through portion 652 along the Y axis.

The receiver portion 653 is a ring-shaped portion provided outside the cylindrical portion 651 as viewed in the +Y direction. The ring-shaped magnet 69 is placed in the receiver portion 653 from a side in the +Y direction.

The plurality of insertion holes 654 are provided at a periphery of the holding member 65 around the rotation axis Rx. Each of screws SC4 is inserted into the corresponding one of the insertion holes 654 in the +Y direction. The holding member 65 and the meshing member 66 are integrated by fixing the screws SC4 to the meshing member 66.

As Illustrated in FIG. 13, the Holding Member 65 Further Includes the Meshing portion 655.

The meshing portion 655 meshes with the meshing member 54 of the table 53. The meshing portion 655 includes a plurality of recesses 6551 provided inside the cylindrical portion 651 to be meshed with the plurality of convex portions 5431 (see FIG. 8) of the meshing member 54. The plurality of convex portions 5431 mesh with the plurality of recesses 6551 to integrate the load adjuster 6 and the table 53, so that the load adjuster 6 and the table 53 are integrally rotatable around the shaft member 51.

It should be noted that the holding member 65, which is incapable of rotation relative to the shaft member 51 due to the meshing portion 655 meshing with the convex portion 5431, is movable along and relative to the shaft member 51. In other words, the holding member 65 is rotatable integrally with the shaft member 51 due to the meshing portion 655 meshing with the convex portion 5431 and is movable along (i.e. in the ±Y directions) and relative to the shaft member 51.

### Configuration of Meshing Member

The meshing member 66 has a larger profile than that of the holding member 65 as viewed in the +Y direction to cover a side of the holding member 65 in the +Y direction. The meshing member 66 meshes with the adjusting member 61 attached to the shaft member 51. As illustrated in FIGS. 12 and 13, the meshing member 66 includes an opening 661, a cover portion 662, a barrel portion 663, and the helical groove 664.

The opening 661 is a circular hole provided at the center of the meshing member 66 as viewed in the +Y direction.

The cover portion 662, which is provided outside the opening 661 as viewed in the +Y direction, is a ring-shaped portion around the rotation axis Rx. The cover portion 662 covers a side of the holding member 65 in the +Y direction when the holding member 65 and the meshing member 66 are combined. A part of the magnet 69 placed on the receiver portion 653 is thus covered with the cover portion 662.

The barrel portion 663 is a hollow cylindrical portion protruding in the +Y direction from the periphery of the opening 661. The adjusting member 61 is attached to the barrel portion 663.

The helical groove 664 is a groove in a form of a helix provided on an inner circumferential surface of the barrel portion 663. The helical groove 664 is shaped to ascend in the +Y direction as going clockwise as viewed in the +Y direction. The outer circumferential protrusion 635 of the adjusting member 61 is inserted into the helical groove 664.

As described above, when the table 53 is meshed with the holding member 65, the intermediate member 64 is rotatable integrally with the shaft member 51 and is movable along (i.e. in the ±Y directions) and relative to the shaft member 51 by the presence of the holding member 65. Accordingly, when the adjusting member 61 attached to the shaft member 51 is rotated in one direction around the rotation axis Rx, the intermediate member 64 is moved in the −Y direction along the shaft member 51. When the adjusting member 61 is rotated in the other direction around the rotation axis Rx, the intermediate member 64 is moved in the +Y direction along the shaft member 51.

As illustrated in FIG. 13, the meshing member 66 includes a plurality of protrusions 665. Each of the plurality of protrusions 665 is a substantially cylindrical boss protruding in the −Y direction from a side of the cover portion 662 in the −Y direction. Though not illustrated in detail, six protrusions 665 are provided substantially at equal intervals in the circumferential direction around the rotation axis Rx. Three protrusions 665 out of the six protrusions 665 each receive the corresponding one of the biasing members 68 (see FIGS. 9 and 10).

### Configurations of Press Member 67 and Biasing Members 68

As illustrated in FIGS. 9 and 10, the press member 67 is combined (i.e. loosely fitted) with the intermediate member 64 via the biasing members 68. When the load adjuster 6 is attached to the shaft member 51, the press member 67 holds the intervening member MT together with the table 53 attracted in the +Y direction by the magnet 69. The press member 67 also presses the intervening member MT toward the placement surface 411 of the turntable 41 when the adjusting member 61 is rotated to move the intermediate member 64 in the −Y direction.

The press member 67 is a ring-shaped component around the rotation axis Rx as viewed in the +Y direction. The pressing surface 67A of the press member 67 facing in the −Y direction is in contact with a surface of the intervening member MT facing in the +Y direction. In other words, the pressing surface 67A is in contact with a surface of the operation disc DS facing in the +Y direction.

It should be noted that an elastic body made of silicone resin or the like is optionally provided on the pressing surface 67A in order to enhance adhesion with the operation disc DS.

The press member 67 includes an opening 671, a positioning portion 672, and a receiver portion 673.

The opening 671 is provided at the center of the press member 67 as viewed in the +Y direction. The shape of the inner periphery of the opening 671 as viewed in the +Y direction corresponds to the shape of the outer periphery of the holding member 65 as viewed in the +Y direction. The holding member 65 is located in the opening 671.

The positioning portion 672 is a pin protruding in the +Y direction from the periphery of the opening 671. The positioning portion 672 is inserted into the holding member 65 to determine the position of the holding member 65 relative to the press member 67.

The receiver portions 673, which are provided at the periphery of the opening 671, each receive the corresponding one of the biasing members 68.

### Adjustment of Rotation Load of Intervening Member by Load Adjuster

FIG. 14 is a side elevational view illustrating the rotary shaft portion 5 and the intervening member MT as viewed in the +Z direction. Specifically, FIG. 14 illustrates the position of the contact surface 552 of the table 53 with respect to the placement surface 411 while the load adjuster 6 is not attached to the shaft member 51. It should be noted that the position of the placement surface 411 is illustrated in a dotted line in FIG. 14.

While the load adjuster 6 is not attached to the shaft member 51, the table 53 is located due to its self weight at an end in the −Y direction within a movable range along the Y axis, as illustrated in FIG. 14. In other words, when the load adjuster 6 is not attached to the shaft member 51, the table 53 is located at a first position for the table 53 to be in contact with the movement restrictor 514.

At this time, the contact surface 552 of the table 53 capable of being in contact with the intervening member MT is located in the −Y direction with respect to the placement surface 411 of the turntable 41. Accordingly, the intervening member MT is supported by the placement surface 411 of the turntable 41, so that the contact surface 552 is not in contact with the intervening member MT.

It should be noted that, in this state, the operation disc DS is placed on the placement surface 411 as in a typical record disc player. Accordingly, a user can immediately exchange the operation disc DS.

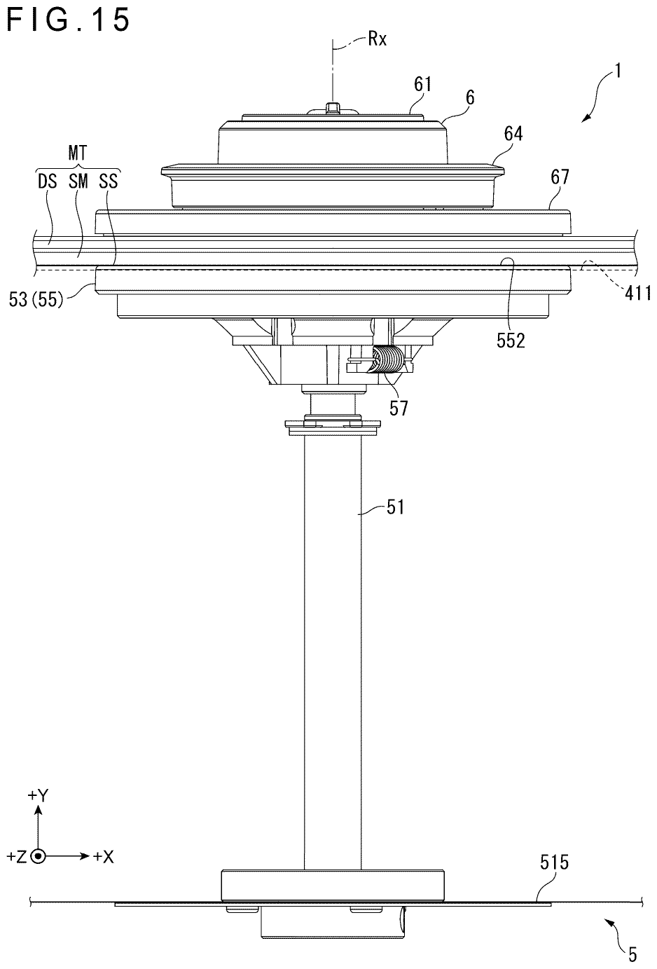

FIG. 15 is a side elevational view illustrating the rotary shaft portion 5, the load adjuster 6, and the intervening member MT as viewed in the +Z direction. Specifically, FIG. 15 illustrates the position of the contact surface 552 of the table 53 with respect to the placement surface 411 while the load adjuster 6 is attached to the shaft member 51. It should be noted that the position of the placement surface 411 is illustrated in a dotted line in FIG. 15.

When the load adjuster 6 is attached to the shaft member 51 in the state illustrated in FIG. 14, the claw 625 (FIG. 11) is inserted into the recess 511. The position of the adjusting member 61 and, consequently, the position of the load adjuster 6 on the shaft member 51 are thus determined.

Meanwhile, the magnet 69 of the load adjuster 6 and the magnet 56 of the table 53 attract each other. However, since the load adjuster 6 is immobile, the table 53 is moved in the +Y direction. Thus, the intervening member MT is held along the Y axis by the pressing surface 67A of the press member 67 of the load adjuster 6 and the contact surface 552 of the holding member 55 of the table 53.

At this time, while the intermediate member 64 and the press member 67 are located at the farthest in the +Y direction in the movable range along the Y axis, the table 53 is located at an end in the +Y direction in the movable range along the Y axis. Supposing that the position of the table 53 at the time is referred to as a second position, when the table 53 is located at the second position, the contact surface 552 of the table 53 is located in the +Y direction with respect to the placement surface 411 as illustrated in FIG. 15. In this state, since the intervening member MT is not likely to be in contact with the placement surface 411 of the turntable 41, the rotation load on the turntable 41 applied by the operation disc DS is minimized.

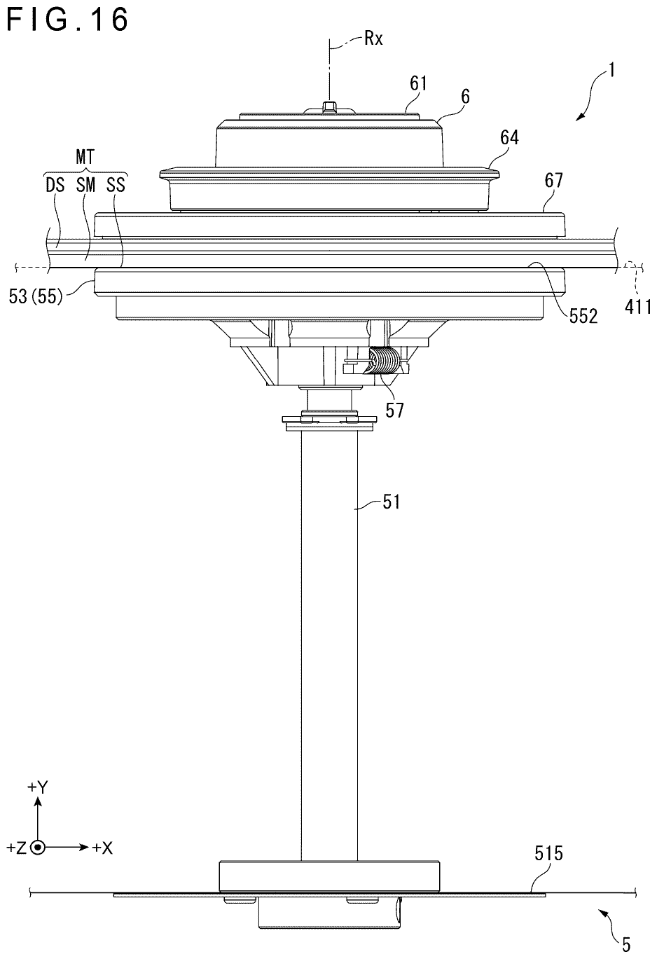

FIG. 16 is a side elevational view illustrating the rotary shaft portion 5, the load adjuster 6, and the intervening member MT as viewed in the +Z direction. More specifically, FIG. 16 is a side elevational view illustrating the rotary shaft portion 5, the load adjuster 6, and the intervening member MT when the adjusting member 61 is rotated to locate the contact surface 552 of the table 53 coplanar with the placement surface 411. It should be noted that the position of the placement surface 411 is illustrated in a dotted line in FIG. 16.

When the adjusting member 61 of the load adjuster 6 is rotated in one direction around the rotation axis Rx in the state illustrated in FIG. 15, the intermediate member 64 and the press member 67 are moved in the −Y direction. The table 53 is thus moved in the −Y direction while holding the intervening member MT together with the press member 67. When the intermediate member 64, the press member 67, and the table 53 are further moved in the −Y direction, the contact surface 552 becomes coplanar with the placement surface 411 as illustrated in FIG. 16. In this case, the intervening member MT is not only supported by the contact surface 552 but also by the placement surface 411 in the −Y direction.

Though not illustrated, when the adjusting member 61 is further rotated to move the intermediate member 64, the press member 67, and the table 53 further in the −Y direction, the intervening member MT is pressed toward the placement surface 411 by the pressing surface 67A of the press member 67. In other words, the intervening member MT is pressed in the −Y direction by the pressing surface 67A.

In this state, the slip sheet SS and the slip mat SM are compressed in the −Y direction to firmly press the operation disc DS against the placement surface 411. Accordingly, the frictional force applied while the operation disc DS is rotated is increased to increase the rotation load of the operation disc DS on the turntable 41.

The pressing force of the intervening member MT against the turntable 41 and, consequently, the rotation load of the operation disc DS on the turntable 41 can be adjusted depending on the rotation amount of the adjusting member 61 around the rotation axis Rx.

It should be noted that, since the load adjuster 6 is easily detachable from the shaft member 51, the operation disc DS can be easily and rapidly exchanged.

As described above, the rotation of the operation disc DS is transmitted to the shaft member 51 via the load adjuster 6 contacting with the operation disc DS and the table 53 meshing with the load adjuster 6, where the rotation state of the shaft member 51 is detected by the second detector 932. Accordingly, the acoustic device 1 can detect the rotation state of the operation disc DS around the rotation axis Rx using the second detector 932 and transmit the detected rotation state of the operation disc DS.

It should be noted that the acoustic device 1 may transmit the acquired information and not transmit the rotation state of the operation disc DS when the tone arm 3 is in use, in other words, when the information recorded in the operation disc DS can be acquired using the tone arm 3.

### Effects of Exemplary Embodiment

The following advantages can be achieved by the acoustic device 1 according to the above-described exemplary embodiment.

The acoustic device 1 includes the base 21, the shaft member 51, the turntable 41, the table 53, and the load adjuster 6.

The shaft member 51 penetrates through the base 21. The turntable 41 provided on the base 21 is rotatable around the shaft member 51.

The table 53 is movable along the shaft member 51. The table 53 corresponds to a movable member.

The load adjuster 6 is attached to the shaft member 51. The load adjuster 6 approaches the turntable 41 along the shaft member and presses the intervening member MT interposed between the load adjuster 6 and the table 53 toward the turntable 41, thereby adjusting the rotation load of the operation disc DS of the intervening member MT applied on the turntable 41. The load adjuster 6 attracts the table 53 by magnetic force to hold the intervening member MT together with the table 53.

According to the above configuration, by attaching the load adjuster 6 to the shaft member 51, the table 53 is attracted by the magnetic force toward the load adjuster 6 to hold the intervening member MT between the load adjuster 6 and the table 53. In this state, the intervening member MT can be pressed in the direction toward the turntable 41 by bringing the load adjuster 6 close to the turntable 41. Accordingly, the rotation load of the operation disc DS of the intervening member MT against the turntable 41 can be easily adjusted.

Further, since the intervening member MT can be released from being held between the load adjuster 6 and the table 53 by detaching the load adjuster 6 from the shaft member 51, the intervening member MT can be placed on the turntable 41. The intervening member MT can thus be stably rotated together with the turntable 41. Accordingly, a mode capable of adjusting the rotation load applied by the operation disc DS on the turntable 41 and a mode capable of stably rotating the operation disc DS by the turntable 41 can be switched by attaching or detaching the load adjuster 6 to/from the shaft member 51. Further, when the load adjuster 6 is removed from the shaft member 51, the operation disc DS is simply placed on the turntable 41 as in a typical record disc player. Accordingly, a user can immediately exchange the operation disc DS.

The acoustic device 1 includes the tone arm 3 capable of contacting with the operation disc DS of the intervening member MT.

According to the above configuration, when the operation disc DS included in the intervening member MT is an analog record disc recorded with audio information or a record disc recorded with a time code (e.g. a record disc such as a time code record disc), the information recorded on the operation disc DS can be acquired by the tone arm 3. The versatility of the acoustic device 1 can thus be enhanced.

The load adjuster 6 of the acoustic device 1 includes the magnet 69 for applying magnetic force on the table 53. The magnet 69 corresponds to a magnetic unit.

According to the above configuration, when the load adjuster 6 is attached to the shaft member 51, the table 53 can be attracted to the load adjuster 6. Accordingly, the intervening member MT can be held by the load adjuster 6 and the table 53.

The table 53 (movable member) of the acoustic device 1 includes the magnet 56. The magnet 56 corresponds to a magnetic body, on which the magnetic force of the magnet 69 acts.

According to the above configuration, when the load adjuster 6 is attached to the shaft member 51, the table 53 can be attracted to the load adjuster 6. Accordingly, the intervening member MT can be held by the load adjuster 6 and the table 53.

The load adjuster 6 of the acoustic device 1 includes the adjusting member 61 and the press member 67.

The adjusting member 61 is capable of rotating around the shaft member 51.

The press member 67 is moved along the shaft member 51 in the −Y direction as the adjusting member 61 is rotated, thereby pressing the intervening member MT toward the turntable 41.

According to the above configuration, the pressing force acting on the intervening member MT and, consequently, the rotation load of the operation disc DS of the intervening member MT acting on the turntable 41 can be controlled by adjusting the rotation amount of the adjusting member. Accordingly, the rotation load of the operation disc DS can be easily controlled.

The turntable 41 of the acoustic device 1 includes the placement surface 411 for the intervening member MT to be capable of being placed. The table 53 includes the contact surface 552 that is in contact with the intervening member MT when the table 53 is attracted to the load adjuster 6. The contact surface 552 is capable of being located at a position closer to the load adjuster 6 with respect to the placement surface 411. In other words, the contact surface 552 is capable of being located in the +Y direction with respect to the placement surface 411.

According to the above configuration, the intervening member MT can be located at a position closer to the load adjuster 6 with respect to the placement surface 411. In other words, the intervening member MT can be floated off the placement surface 411. The intervening member MT can thus be located so as not to be in contact with the turntable 41. Accordingly, the rotation load applied by the operation disc DS of the intervening member MT can be reduced. The adjustable range of the rotation load of the operation disc DS can thus be enlarged.

The turntable 41 of the acoustic device 1 includes the opening 412 through which the shaft member 51 is inserted. The table 53 is located inside the opening 412 as viewed on the side of the load adjuster 6 with respect to the table 53. In other words, the table 53 is located inside the opening 412 as viewed in the +Y direction.

According to the above configuration, when the contact surface 552 is located at a position closer to the load adjuster 6 with respect to the placement surface 411, the intervening member MT can be more easily supported by the table 53 in a manner rotatable around the shaft member 51 independently of the turntable 41. Accordingly, the intervening member MT can be stably supported in a rotatable manner solely by the table 53.

The acoustic device 1 includes the turntable 41, the shaft member 51, the table 53, and the load adjuster 6.

The turntable 41 includes the placement surface 411 for the operation disc DS (disc) to be capable of being placed. The turntable 41 is rotatable together with the operation disc DS around the shaft member 51.

The shaft member 51 penetrates through the turntable 41.

The table 53 includes the contact surface 552 capable of being contact with the operation disc DS. The table 53 is movable along the shaft member 51. The table 53 corresponds to the movable member.

The load adjuster 6, which is attached to the shaft member 51, attracts the table 53 by magnetic force to hold the operation disc DS together with the table 53. The load adjuster 6 approaches the turntable 41 along the shaft member and presses the operation disc DS interposed between the load adjuster 6 and the table 53 toward the turntable 41, thereby adjusting the rotation load of the operation disc DS applied on the turntable 41.

The table 53 is movable between the first position, at which the contact surface 552 is located opposite the load adjuster 6 with respect to the placement surface 411, and the second position, at which the contact surface 552 is located near the load adjuster 6 with respect to the placement surface 411. In other words, the table 53 is movable between the first position, at which the contact surface 552 is located in the +Y direction with respect to the placement surface 411, and the second position, at which the contact surface 552 is located in the −Y direction with respect to the placement surface 411.

According to the above configuration of the acoustic device 1, the rotation load applied on the turntable 41 by the operation disc DS can be easily adjusted. Further, a mode capable of adjusting the rotation load applied by the operation disc DS on the turntable 41 and a mode capable of stably rotating the operation disc DS by the turntable 41 can be switched by attaching or detaching the load adjuster 6 to/from the shaft member 51.

In addition, by locating the table 53 at the first position, the rotation load applied on the turntable 41 by the operation disc DS can be adjusted by the load adjuster 6. By locating the table 53 at the second position, the operation disc DS held between the load adjuster 6 and the table 53 can be supported independently of the turntable 41. Accordingly, the adjustable range of the rotation load applied by the operation disc DS can be enlarged by the table 53 that is movable between the first and second positions.

### Modification of Exemplary Embodiments

The scope of the invention is not limited by the above exemplary embodiment but includes any modification and improvement as long as such modification and improvement are compatible with the invention.

The acoustic device 1 according to the above exemplary embodiment includes the tone arm 3. However, the tone arm 3 is not requisite and the acoustic device 1 optionally does not include the tone arm 3.

In the above exemplary embodiment, the table 53 and the load adjuster 6 include the magnet 56 and the magnet 69, respectively, that attract each other. However, instead of the above, one of the magnets 56, 69 is optionally replaced with a magnetic body (e.g. a metal body). In other words, one of the table 53 and the load adjuster 6 optionally includes a magnet, whereas the other of the table 53 and the load adjuster 6 optionally includes a magnetic body to be attracted by the magnet.

According to the above exemplary embodiment, the load adjuster 6 includes: the adjusting member 61 attached to the shaft member 51 and rotated by a user around the rotation axis Rx; the intermediate member 64 meshing with the adjusting member 61 to be moved in the ±Y directions along the shaft member 51; the press member 67 connected with the intermediate member 64 to press the intervening member MT toward the turntable 41; the biasing members 68 interposed between the intermediate member 64 and the press member 67; and the magnet 69. However, the above configuration is not requisite but the intermediate member 64 is optionally integrated with the press member 67. In other words, the press member 67 may include the configuration of the intermediate member 64, where the press member 67 may be directly meshed with the adjusting member 61. In this case, the press member 67 can approach the turntable 41 depending on the rotation amount of the adjusting member 61.

In the above exemplary embodiment, the table 53 (movable member) is capable of being located so that the contact surface 552 capable of being in contact with the intervening member MT is located near the load adjuster 6 with respect to the placement surface 411 of the turntable 41. In other words, the table 53 is capable of being located at the second position. However, the above arrangement is not requisite but the end of the table 53 in the +Y direction in the movable range along the shaft member 51 is optionally located at a position for the contact surface 552 to be coplanar with the placement surface 411. In other words, the table 53 is not necessarily located at a position for the contact surface 552 to be located in the +Y direction with respect to the placement surface 411.

In the above exemplary embodiment, the turntable 41 includes the opening 412 for the shaft member 51 to be inserted along the Y axis and for exposing the table 53. However, the above configuration is not requisite but the opening 412 of the turntable 41 for exposing the table 53 is optionally located at other part.

### Gist of the Invention

Gist of the invention will be described below.

[1] An acoustic device includes:
a base;
a shaft member penetrating through the base;
a turntable provided on the base, the turntable being rotatable around the shaft member;
a movable member provided in a manner movable along the shaft member; and
a load adjuster attached to the shaft member, the load adjuster being configured to approach the turntable along the shaft member and press an intervening member interposed between the load adjuster and the movable member toward the turntable to adjust a rotation load of the intervening member on the turntable, in which

the load adjuster is configured to attract the movable member by a magnetic force to hold the intervening member together with the movable member.

According to the above configuration, by attaching the load adjuster to the shaft member, the movable member is attracted by the magnetic force toward the load adjuster to hold the intervening member between the load adjuster and the movable member. In this state, the intervening member can be pressed in the direction toward the turntable by bringing the load adjuster close to the turntable. Accordingly, the rotation load of the intervening member to the turntable can be easily adjusted.

Further, since the intervening member can be released from being held between the load adjuster and the movable member by detaching the load adjuster from the shaft member, the intervening member can be placed on the turntable. The intervening member can thus be stably rotated together with the turntable. Accordingly, a mode capable of adjusting the rotation load applied by the intervening member on the turntable and a mode capable of stably rotating the intervening member by the turntable can be switched by attaching or detaching the load adjuster to/from the shaft member.

[2] The acoustic device according to [1] further includes a tone arm capable of contacting with the intervening member.

According to the above configuration, when the intervening member includes an analog record disc recorded with audio information and a record disc recorded with a time code (e.g. a time code record disc), the information recorded on the record disc can be acquired by the tone arm. The versatility of the acoustic device can thus be enhanced.

[3] In the acoustic device according to [1] or [2], the load adjuster includes a magnetic unit configured to apply the magnetic force on the movable member.

According to the above configuration, when the load adjuster is attached to the shaft member, the movable member can be easily attracted to the load adjuster. Accordingly, the intervening member can be easily held between the load adjuster and the movable member.

[4] In the acoustic device according to any one of [1] to [3], the movable member has a magnetic body on which the magnetic force acts.

According to the above configuration, when the load adjuster is attached to the shaft member, the movable member can be easily attracted to the load adjuster. Accordingly, the intervening member can be easily held between the load adjuster and the movable member.

[5] In the acoustic device according to any one of [1] to [4], the load adjuster includes:
an adjusting member rotatable around the shaft member; and
a press member configured to move along the shaft member as the adjusting member is rotated and press the intervening member toward the turntable.

According to the above configuration, the press member moves along the shaft member to press the intervening member against the turntable by rotating the adjusting member. According to the above configuration, the pressing force acting on the intervening member and, consequently, the rotation load of the intervening member acting on the turntable can thus be controlled by adjusting the rotation amount of the adjusting member. Accordingly, the rotation load of the intervening member can be easily adjusted.

[6] In the acoustic device according to any one of [1] to [5],
the turntable has a placement surface on which the intervening member is placed,
the movable member has a contact surface that is in contact with the intervening member when the movable member is attracted to the load adjuster, and
the contact surface is capable of being located at a position closer to the load adjuster with respect to the placement surface.

According to the above configuration, the intervening member can be located at a position closer to the load adjuster with respect to the placement surface. In other words, the intervening member can be floated off the placement surface. The intervening member can thus be located so as not to be in contact with the turntable. Accordingly, the rotation load of the intervening member can be reduced. Adjustable range of the rotation load of the intervening member can thus be enlarged.

[7] In the acoustic device according to [6],
the turntable has an opening through which the shaft member is inserted, and
the movable member is located inside the opening as viewed from a side near the load adjuster with respect to the movable member.

According to the above configuration, when the contact surface is located at a position closer to the load adjuster with respect to the placement surface, the intervening member can be more easily supported by the movable member in a manner rotatable around the shaft member independently of the turntable. Accordingly, the intervening member can be stably supported in a rotatable manner solely by the movable member.

[8] An acoustic device includes:
a turntable having a placement surface for a disc to be capable of being placed, the turntable being rotatable together with the disc;
a shaft member penetrating through the turntable;
a movable member having a contact surface capable of contacting with the disc, the movable member being provided in a manner movable along the shaft member; and
a load adjuster attached to the shaft member, the load adjuster being configured to approach the turntable along the shaft member and press the disc interposed between the load adjuster and the movable member toward the turntable to adjust a rotation load of the disc on the turntable, in which
the turntable is rotatable around the shaft member,
the load adjuster is configured to attract the movable member by a magnetic force to hold the disc together with the movable member, and
the movable member is movable between a first position, at which the contact surface is located opposite the load adjuster with respect to the placement surface, and a second position, at which the contact surface is located near the load adjuster with respect to the placement surface.

According to the above configuration, the rotation load applied on the turntable by the disc can be easily adjusted as in the above acoustic device. Further, a mode capable of adjusting the rotation load applied by the disc on the turntable and a mode capable of stably rotating the disc by the turntable can be switched by attaching or detaching the load adjuster to/from the shaft member.

Further, by locating the movable member at the first position, the rotation load applied on the turntable by the disc can be adjusted by the load adjuster. By locating the movable member at the second position, the disc held between the load adjuster and the movable member can be supported independently of the turntable. Accordingly, the adjustable range of the rotation load applied by the disc can be enlarged by the movable member that is movable between the first and second positions.

### EXPLANATION OF CODES

1 . . . acoustic device, 2 . . . casing, 21 . . . base, 3 . . . tone arm, 4 . . . rotary body, 41 . . . turntable, 411 . . . placement surface, 412 . . . opening, 5 . . . rotary shaft portion, 51 . . . shaft member, 52 . . . connector, 53 . . . table (movable member), 552 . . . contact surface, 56 . . . magnet (magnetic body), 6 . . . load adjuster, 61 . . . adjusting member, 64 . . . intermediate member, 67 . . . press member, 69 . . . magnet (magnetic unit), DS . . . operation disc (disc), MT . . . intervening member

1. An acoustic device comprising:
a base;
a shaft member penetrating through the base;
a turntable provided on the base, the turntable being rotatable around the shaft member;
a movable member provided in a manner movable along the shaft member; and
a load adjuster attached to the shaft member, the load adjuster being configured to approach the turntable along the shaft member and press an intervening member interposed between the load adjuster and the movable member toward the turntable to adjust a rotation load of the intervening member on the turntable, wherein
the load adjuster is configured to attract the movable member by a magnetic force to hold the intervening member together with the movable member.

2. The acoustic device according to claim 1, further comprising:
a tone arm capable of contacting with the intervening member.

3. The acoustic device according to claim 1, wherein the load adjuster comprises a magnetic unit configured to apply the magnetic force on the movable member.

4. The acoustic device according to claim 1, wherein the movable member comprises a magnetic body on which the magnetic force acts.

5. The acoustic device according to claim 1, wherein
the load adjuster comprises:
an adjusting member rotatable around the shaft member; and
a press member configured to move along the shaft member as the adjusting member is rotated and press the intervening member toward the turntable.

6. The acoustic device according to claim 1, wherein
the turntable has a placement surface on which the intervening member is placed,
the movable member has a contact surface that is in contact with the intervening member when the movable member is attracted to the load adjuster, and
the contact surface is capable of being located at a position closer to the load adjuster with respect to the placement surface.

7. The acoustic device according to claim 6, wherein
the turntable has an opening through which the shaft member is inserted, and
the movable member is located inside the opening as viewed from a side near the load adjuster with respect to the movable member.

8. An acoustic device comprising:
a turntable having a placement surface on which a disc is placeable, the turntable being rotatable together with the disc;
a shaft member penetrating through the turntable;
a movable member having a contact surface capable of contacting with the disc, the movable member being provided in a manner movable along the shaft member; and
a load adjuster attached to the shaft member, the load adjuster being configured to approach the turntable along the shaft member and press the disc interposed between the load adjuster and the movable member toward the turntable to adjust a rotation load of the disc on the turntable, wherein
the turntable is rotatable around the shaft member,
the load adjuster is configured to attract the movable member by a magnetic force to hold the disc together with the movable member, and
the movable member is movable between a first position, at which the contact surface is located opposite the load adjuster with respect to the placement surface, and a second position, at which the contact surface is located near the load adjuster with respect to the placement surface.
